(19) United States
(12) Patent Application Publication
(10) Pub. No.: US 2010/0150380 A1
(43) Pub. Date: Jun. 17, 2010

(54) Interface connector and method of controlling the same

(75) Inventors: Ki Hyun Jun, Metropolitan City (KR); Young Hoon Kim, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/653,626

(22) Filed: Dec. 16, 2009

(30) Foreign Application Priority Data
Dec. 17, 2008 (KR) 10-2008-0128255

(51) Int. Cl. H02B 1/00; H01R 24/04

(52) U.S. Cl. 381/123; 439/668

(57) ABSTRACT

An interface connector and a method of controlling the same includes: an upper connector including a plurality of first terminals; a lower connector including a plurality of second terminals insulated from the plurality of first terminals. A determination unit determines which one of an earphone plug and an interface plug is connected to the interface connector through signals output from at least one of the plurality of first terminals and the plurality of second terminals. A switching unit switches signal lines from the plurality of first terminals. A controller controls the determination unit, the audio processor, the data processor, and the switching unit to perform a function corresponding to the connected one of the earphone plug and the interface plug, according to the determination result of the determination unit.

### CROSS-REFERENCE TO RELATED APPLICATION(S) AND CLAIM OF PRIORITY

The present application is related to and claims priority to an application entitled “INTERFACE CONNECTOR AND METHOD OF CONTROLLING THE SAME” filed in the Korean Intellectual Property Office on Dec. 17, 2008 and assigned Serial No. 10-2008-0128255, the contents of which are incorporated herein by reference.

### TECHNICAL FIELD OF THE INVENTION

The present invention relates to an interface connector, and more particularly, to an interface connector and a method of controlling the same that can connect to both an earphone and a data cable such as a USB cable.

### BACKGROUND OF THE INVENTION

In general, a mobile terminal is an electronic device with which a user can perform a function such as wireless communication, network connection, and digital broadcasting reception almost regardless of time and location. Currently, mobile terminals are developed to perform functions such as Internet connection and digital broadcasting reception as well as a communication function. Further, functions such as document writing and game playing are added to the mobile terminal.

Such a mobile terminal may require an earphone connector for connecting an earphone, and an interface connector for connecting a USB cable for performing data communication and a charging cable for performing electric charging. When the mobile terminal includes an earphone connector and a separate interface connector, the mobile terminal requires additional space; however, it is difficult to decrease the size of the mobile terminal.

In order to solve the problem, an earphone, USB cable, or charging cable can be connected through an interface connector without requiring a conventional earphone connector. However, in this case, because an exclusive earphone including an earphone plug that can be connected to the interface connector of the mobile terminal should be used, a conventional earphone for a Moving Picture Experts Group layer-3 (MP3) player cannot be used. Further, when using a conventional earphone, the conventional earphone should be connected to an interface connector using a separate converter plug. Further, because the interface connector of the mobile terminal generally comprises a flat and wide shape, the interface plug cannot be easily inserted into the interface connector, and if the interface plug is not appropriately inserted into the interface plug, the interface connector may be damaged.

Therefore, an interface connector and a method of controlling the same that can connect with a data cable such as a USB cable as well as with a generally used conventional earphone are requested.

### SUMMARY OF THE INVENTION

To address the above-discussed deficiencies of the prior art, it is a primary object to provide an interface connector, and a method of controlling the same, that can connect with a plug of a data cable, such as a USB cable, as well as with a generally used conventional earphone plug without requiring separate interface connectors to connect with an earphone plug of an earphone cable and a plug of a data cable, such as a USB cable.

In accordance with an aspect of the present invention, an interface connector includes: an upper connector that includes a plurality of first terminals; a lower connector that includes a plurality of second terminals insulated from the plurality of first terminals; a determination unit configured to determine which one of an earphone plug and an interface plug is connected to the interface connector through signals output from at least one of the plurality of first terminals and the plurality of second terminals; a switching unit configured to switch signal lines from the plurality of first terminals to connect the plurality of first terminals to one of an audio processor configured to output a sound signal through the earphone plug and a data processor configured to perform one of data communication, electric charging, and a zig test through the interface plug, according to the determination result of the determination unit; and a controller configured to control the determination unit, the audio processor, the data processor, and the switching unit in order to perform a function corresponding to the connected one of the earphone plug and the interface plug, according to the determination result of the determination unit.

In accordance with another aspect of the present invention, a method of controlling an interface connector including an upper connector that includes a plurality of first terminals and a lower connector that includes a plurality of second terminals insulated from the plurality of first terminals, includes: determining which one of an earphone plug and an interface plug is connected to the interface connector through signals output from at least one of the plurality of first terminals and the plurality of second terminals; connecting the plurality of first terminals to one of an audio processor for outputting a sound signal through the earphone plug and a data processor for performing one of data communication, electric charging and a zig test through the interface plug, by switching signal lines from the plurality of first terminals according to the determination result; and controlling a function corresponding to the connected one of the earphone plug and the interface plug, according to the determination result.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a process of connecting an earphone and a data cable to a mobile terminal;

FIG. 2 illustrates a configuration of an interface connector according to an exemplary embodiment of the present invention;

FIG. 3A illustrates a coupled form of an upper connector and a lower connector of the interface connector of FIG. 2;

FIG. 3B illustrates a configuration of the upper connector of the interface connector of FIG. 2;

FIG. 3C illustrates a configuration of the lower connector of the interface connector of FIG. 2;

FIG. 4A illustrates a coupled form of an upper plug and a lower plug of an interface plug according to another exemplary embodiment of the present invention;

FIG. 4B illustrates a configuration of the upper plug of the interface plug of FIG. 4A;

FIG. 5 illustrates a configuration of an earphone plug connected to the interface connector of FIG. 2;

FIG. 6 illustrates a configuration of the interface plug of FIG. 4A connected to the interface connector of FIG. 2; and

FIG. 7 illustrates a method of controlling an interface connector according to another exemplary embodiment of the present invention.

### DETAILED DESCRIPTION OF THE INVENTION

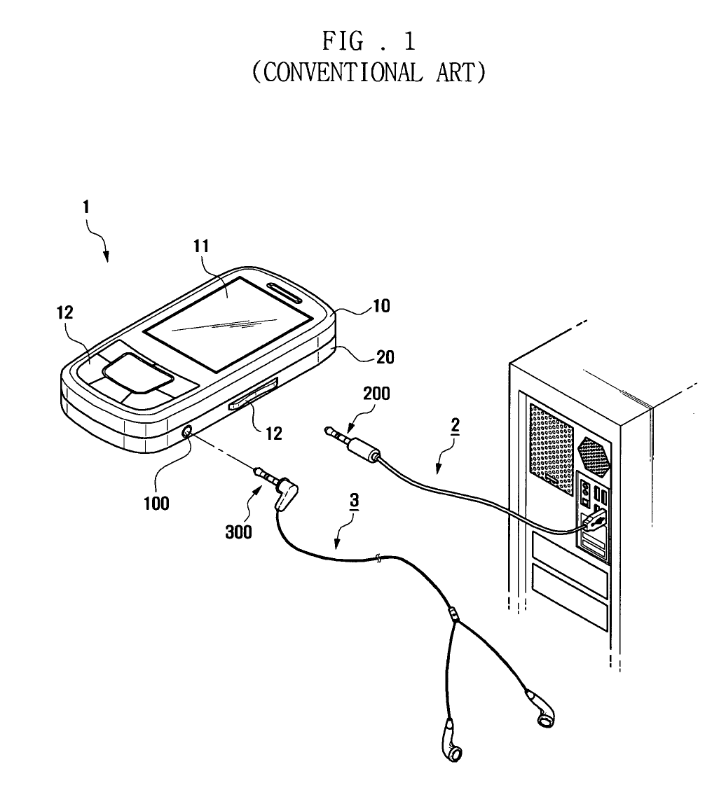

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminal. The views in the drawings are schematic views only, and are not intended to be to scale or correctly proportioned. Detailed descriptions of well-known functions and structures incorporated herein may be omitted to avoid obscuring the subject matter of the present invention.

While the present invention may be embodied in many different forms, specific embodiments of the present invention are shown in drawings and are described herein in detail, with the understanding that the present disclosure is to be considered as an exemplification of the principles of the invention and is not intended to limit the invention to the specific embodiments illustrated.

FIG. 1 illustrates a process of connecting an earphone or a data cable to a mobile terminal.

FIG. 1 illustrates a slide type mobile terminal 1, however the present invention is not limited thereto and can also be applied to a bar type, flip type, folder type, rotating type, and combination type mobile terminal.

Referring to FIG. 1, the slide type mobile terminal 1 includes an upper case 10 that includes a display unit 11 at a front surface thereof and a lower case 20 that includes a key input unit (not shown). The upper case 10 can move by sliding on the lower case 20. The upper case 10 or the lower case 20 includes a sliding unit (not shown) for guiding movement of the upper case 10 by sliding.

The display unit 11 performs a function of outputting a desired screen to a user, and as a user interface for receiving an instruction from the user. A liquid crystal display (LCD), organic light emitting diodes (OLED), thin film transistor (TFT), electrophoretic technology, and laser induced thermal image (LITI) technology can be used in the display unit 11.

Although not shown in FIG. 1, a key input unit for receiving a manipulation instruction of a user is formed in an upper surface of the lower case 20, and the upper surface of the lower case 20 is exposed to the outside while moving by sliding. Further, an auxiliary key input unit 12 for receiving a manipulation instruction from the user is formed in any of an upper surface and a side surface of the upper case 10 and a side surface of the lower case 20. The auxiliary key input unit 12 includes function keys for receiving an instruction from the user in a state when the key input unit of the lower case 20 is not exposed to the outside.

As shown in FIG. 1, the mobile terminal 1 includes an interface connector 100 in a side of one of the upper case 10 and the lower case 20 into which an earphone 3 and a data cable 2 such as a USB cable can be detachably inserted. Here, the data cable 2 indicates various kinds of cables other than an earphone cable, such as a USB cable for performing data communication, a charging cable for electrically charging the mobile terminal 1, and a zig cable used for performing a part test (hereinafter, a ‘zig test’) of the mobile terminal 1 in a process of manufacturing the mobile terminal 1.

The earphone 3 and the data cable 2 are connected in an identical manner to a single common interface of the interface connector 100 according to the present exemplary embodiment, that is, the interface connector 100 does not have a divided interface for each of the earphone 3 and the data cable 2. A plurality of terminals are provided at the inside of the interface connector 100 such that, when one of the earphone 3 and the data cable 2 is connected to the interface connector 100, the mobile terminal 1 determines which one of the earphone plug 300 of the earphone 3 and the interface plug 200 of the data cable 2 is connected to the interface connector 100, and performs a function corresponding to the connected one of earphone 3 and the data cable 2.

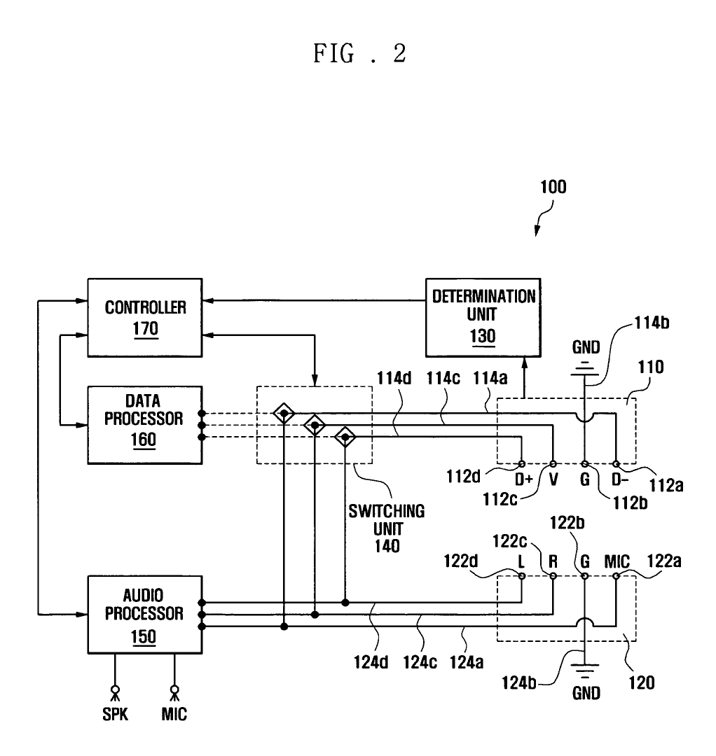

FIG. 2 illustrates a configuration of an interface connector according to an exemplary embodiment of the present invention.

Referring to FIG. 2, the interface connector 100 according to the present exemplary embodiment includes an upper connector 110, lower connector 120, determination unit 130, switching unit 140, audio processor 150, data processor 160, and controller 170.

The upper connector 110 includes a plurality of first terminals 112a, 112b, 112c, and 112d, and the lower connector 120 includes a plurality of second terminals 122a, 122b, 122c, and 122d. Preferably, as shown in FIG. 2, the plurality of first terminals 112a to 112d of the upper connector 110 are a first data signal input terminal (D−), ground terminal (GND), voltage terminal (Vin), and second data signal input terminal (D+), respectively. Further, the plurality of second terminals 122a to 122d of the lower connector 120 are a microphone terminal (MIC), ground terminal (GND), ear right terminal (EAR-R), and ear left terminal (EAR-L), respectively.

As shown in FIG. 2, a plurality of signal lines 114a, 114b, 114c, and 114d and a plurality of signal lines 124a, 124b, 124c, and 124d connect the plurality of first terminals 112a to 112d and the plurality of second terminals 122a to 122d, respectively, to one of the audio processor 150 and the data processor 160. When the earphone plug 300 or the interface plug 200 is connected to the interface connector 100, each of the terminals 112a to 112d and 122a to 122d contacts with a connection terminal of the earphone plug 300 or the interface plug 200, and is connected through the corresponding signal line to the audio processor 150 or the data processor 160. The signal lines thereby perform a function of a path for transmitting an electrical signal in order to perform a corresponding function.

The signal lines 114a, 114c, and 114d (hereinafter, the first signal line 114a, second signal line 114c, and third signal line 114d, respectively) connect the first data signal input terminal (D−) 112a, voltage terminal (Vin) 112c, and second data signal input terminal (D+) 112d, respectively, of the upper connector 110 to the audio processor 150 or the data processor 160, whereby when the interface plug 200 is connected to the interface connector 100, the first signal line 114a, second signal line 114c, and third signal line 114d form paths for transmitting a signal for performing data communication, electric charging or a zig test. The signal line 114b (hereinafter, the first ground line 114b) is connected to the ground terminal (GND) 112b of the upper connector 110, and forms a path for connecting a ground terminal of the earphone plug 300 or the interface plug 200 to the ground GND.

The signal lines 124a, 124c, and 124d (hereinafter, the fourth signal line 124a, fifth signal line 124c, and sixth signal line 124d, respectively) connect the microphone terminal (MIC) 122a, ear right terminal (EAR-R) 122c, and ear left terminal (EAR-L) 122d, respectively, of the lower connector 120 to the audio processor 150, whereby when the earphone plug 300 is connected to the interface connector 100, the fourth signal line 124a, fifth signal line 124c, and sixth signal line 124d form paths for transmitting an audio signal for outputting sound. The signal line 124b (hereinafter, the second ground line 124b) is connected to the ground terminal (GND) 122b of the lower connector 120, and forms a path for connecting a ground terminal of the earphone plug 300 to the ground GND.

The first signal line 114a, second signal line 114c and third signal line 114d connected to the first terminals 112a, 112c, and 112d are switched and connected to one of the audio processor 150 and the data processor 160 through the switching unit 140, described later in detail.

Although not shown in FIG. 2, the interface connector 100 may further include a voltage supply unit for supplying a predetermined voltage to the first terminals 112a, 112c, and 112d and the second terminals 122a, 122c, and 122d through the corresponding signal line.

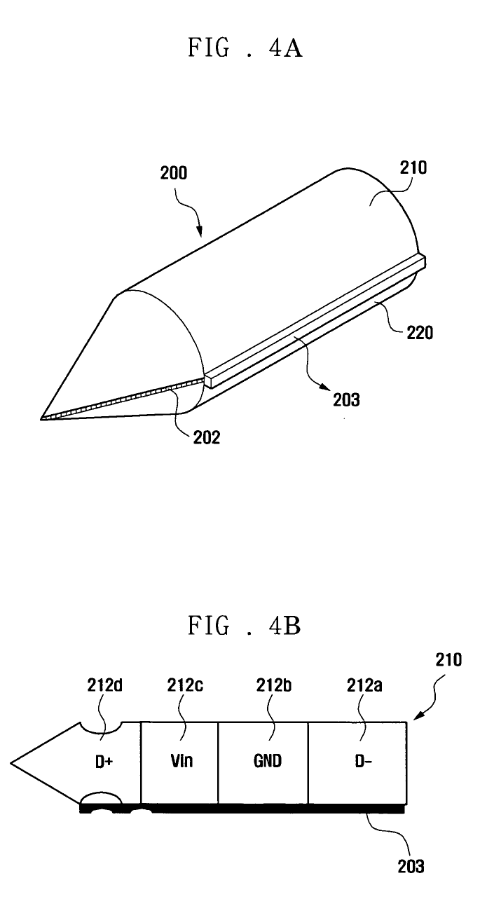

The plurality of first terminals 112a to 112d provided in the upper connector 110 and the plurality of second terminals 122a to 122d provided in the lower connector 120 output the corresponding signal according to which of the earphone plug 300 of the earphone 3 and the interface plug 200 of the data cable 2 is connected to the interface connector 100. A structure of the upper connector 110 and the lower connector 120 is described in detail later with reference to FIGS. 4A to 4B.

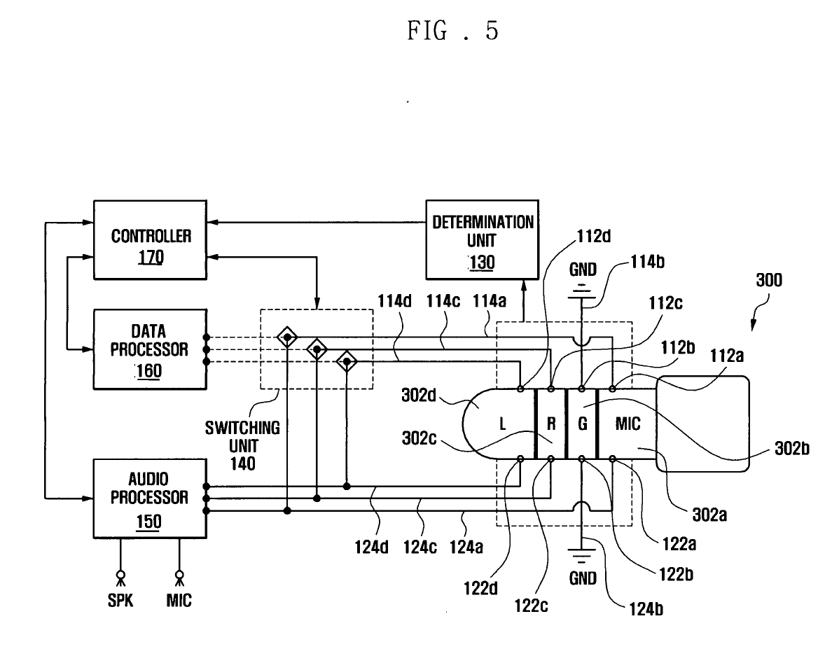

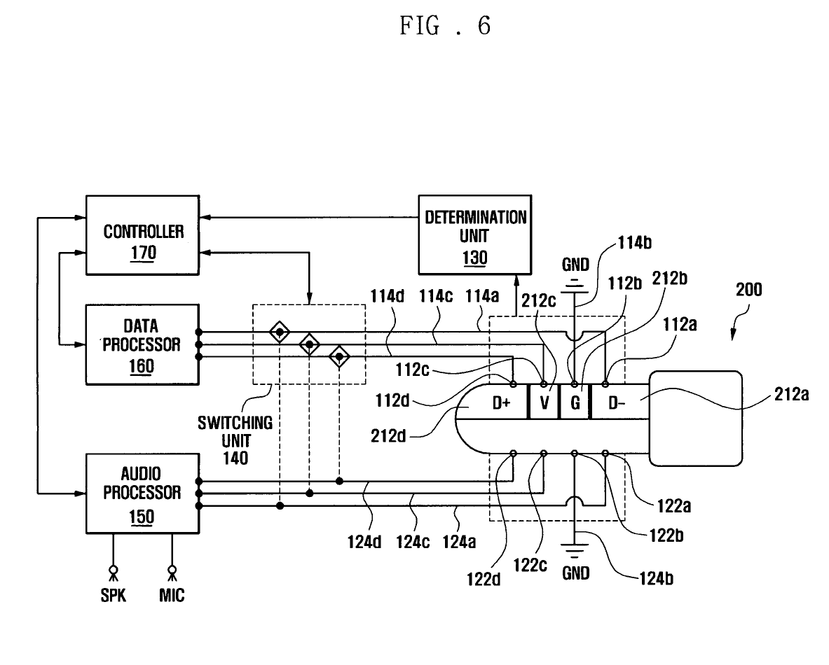

The determination unit 130 determines which of the earphone plug 300 and the interface plug 200 is connected through signals output from the plurality of first terminals 112a to 112d and the plurality of second terminals 122a to 122d. Preferably, the determination unit 130 determines which of the earphone plug 300 and the interface plug 200 is connected using a first signal output from the second data signal input terminal (D+) 112d among the plurality of first terminals 112a to 112d formed in the upper connector 110, and a second signal output from the voltage terminal (Vin) 112c. A method in which the determination unit 130 determines which of the earphone plug 300 and the interface plug 200 is connected using the first signal and the second signal is described in detail later with reference FIGS. 5 to 7.

The determination unit 130 determines which of the earphone plug 300 and the interface plug 200 is connected to the interface connector 100, and the switching unit 140 switches the signal lines 114a, 114c, and 114d from the first terminals 112a, 112c, and 112d of the upper connector 110 according to the determination result and connects the signal lines 114a, 114c, and 114d to the audio processor 150 or the data processor 160. As shown in FIG. 2, in an initial state before the earphone plug 300 or the interface plug 200 is connected to the interface connector 100, in the switching unit 140, the signal lines 114a, 114c, and 114d from the first terminals 112a, 112c, and 112d of the upper connector 110 are connected to the audio processor 150.

When the earphone plug 300 is connected to the interface connector 100, the audio processor 150 outputs a sound signal through the earphone 3. Further, operation of a speaker SPK and a microphone MIC connected to the audio processor 150 is controlled according to whether the earphone plug 300 is connected to the interface connector 100.

When the interface plug 200 of the data cable 2 is connected to the interface connector 100, the data processor 160 performs a function of the data cable 2. That is, when the connected data cable 2 is a USB cable, the data processor 160 performs data communication; when the connected data cable 2 is a charging cable, the data processor 160 performs electric charging; and when the connected data cable 2 is a zig cable, the data processor 160 performs a zig test. In a process of manufacturing the mobile terminal 1 using the interface connector 100, a zig or jig cable is a cable used for performing a test (zig test) of components.

The controller 170 controls the determination unit 130, the switching unit 140, the audio processor 150 and the data processor 160 to perform a function corresponding to the connected earphone plug 300 or interface plug 200 according to a determination result of the determination unit 130 based on signals output from the upper connector 110 and the lower connector 120.

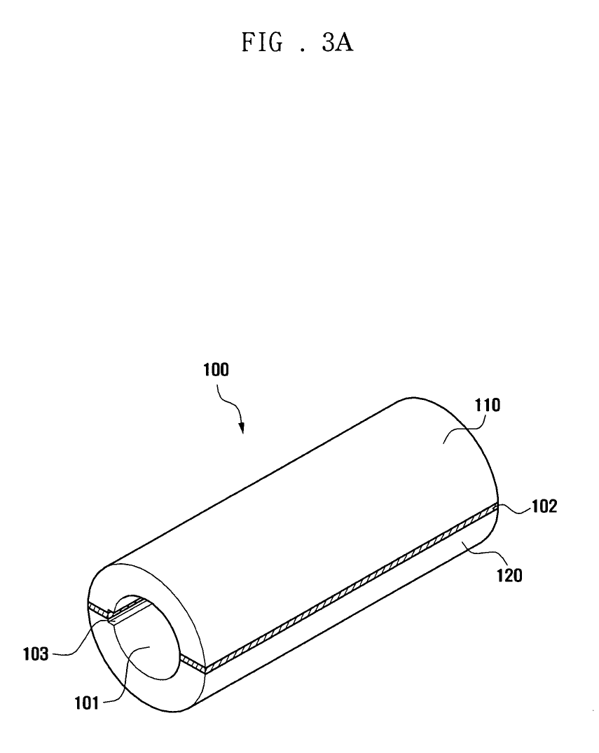

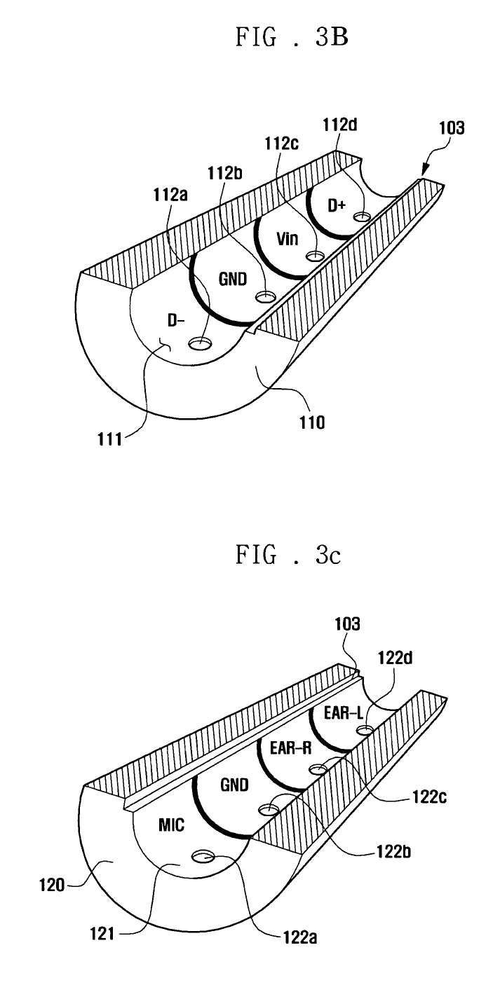

A structure of the interface connector 100 and the interface plug 200 according to the present exemplary embodiment is described hereinafter in detail with reference to FIGS. 3A, 3B, 3C, 4A, and 4B.

FIG. 3A illustrates a coupled form of the upper connector 110 and the lower connector 120 of the interface connector 100, FIG. 3B illustrates a configuration of the upper connector 110 of the interface connector 100, and FIG. 3C illustrates a configuration of the lower connector 120 of the interface connector 100.

FIG. 3A illustrates an interface connector 100 in which the upper connector 110 and the lower connector 120 are along a longitudinal axis of the interface connector 100. The upper connector 110 and the lower connector 120 are coupled opposite each other, and are insulated from each other with an insulator film 102 interposed there between. The coupled upper connector 110 and lower connector 120 thereby form a connector 101 into which the earphone plug 300 and the interface plug 200 can be inserted.

Referring to FIG. 3B, a first recess 111 is formed longitudinally along an inner surface of the upper connector 110, and the plurality of first terminals 112a to 112d are formed sequentially in a longitudinal direction of the first recess 111.

Referring to FIG. 3C, a second recess 121 is formed longitudinally along an inner surface of the lower connector 120, and the plurality of second terminals 122a to 122d are formed sequentially in a longitudinal direction of the second recess 121.

The plurality of first terminals 112a to 112d of the upper connector 110 are formed in order of the first data signal input terminal (D−) 112a, ground terminal GND 112b, voltage terminal (Vin) 112c, second data signal input terminal (D+) 112d from the outer end of the connector 101 of the interface connector 100. Further, the plurality of second terminals 122a to 122d of the lower connector 120 are formed in order of the microphone terminal (MIC) 122a, ground terminal GND 122b, ear right terminal (EAR-R) 122c, and ear left terminal (EAR-L) 122d from the outer end of the connector 101 of the interface connector 100. Each terminal constituting the plurality of first terminals 112a to 112d and the plurality of second terminals 122a to 122d is insulated from the outer terminals.

The kind and arrangement form of the plurality of first terminals 112a to 112d and the plurality of second terminals 122a to 122d illustrated in FIGS. 3B and 3C are an example only, and are not limited thereto.

A guide recess 103 is formed in a longitudinal direction along a coupled surface of the upper connector 110 and the lower connector 120, in order to guide insertion of the interface plug 200 through a projection 203 formed in a side surface of the interface plug 200.

In order to apply the interface connector 100 according to the present exemplary embodiment, the interface plug 200 is provided to have the same form as that of the earphone plug 300, in place of a more common interface plug provided for the data cable 2 such as a general USB cable.

FIG. 4A illustrates a coupled form of an upper plug and a lower plug of the interface plug 200 according to another exemplary embodiment of the present invention, and FIG. 4B illustrates a configuration of the upper plug of the interface plug 200 of FIG. 4A.

FIG. 4A illustrates the interface plug 200, in which an upper plug 210 and a lower plug 220 are along a longitudinal axis of the interface plug 200. The upper plug 210 and the lower plug 220 are coupled opposite each other, and are insulated from each other with an insulator film 202 interposed there between. The lower plug 220 is coupled to the upper plug 210 to enable the interface plug 200 to have the same cylindrical form as that of the general earphone plug 300. It is preferable that the lower plug 220 is not otherwise electrically conductive, so that when the lower plug 220 is connected to the interface connector 100, the lower plug 220 forms neither plated electrical connection to the plurality of second terminals 122a to 122d of the lower connector 120.

Referring to FIG. 4B, connection terminals 212a, 212b, 212c, and 212d are formed in the upper plug 210, such that when the interface plug 200 is inserted into the connector 101 of the interface connector 100, the plurality of connection terminal 212a to 212d contact with the plurality of first terminals 112a to 112d, respectively. From the end of the upper plug 210 corresponding to the connector 101 when the upper plug 210 is connected to the interface connector 100, the plurality of connection terminals 212a to 212d of the upper plug 210 are formed in order of the first data signal input terminal (D−) 212a, ground terminal (GND) 212b, voltage terminal Vin 212c, and second data signal input terminal (D+) 212d.

A projection 203 is formed in a longitudinal direction along a coupled surface of the upper plug 210 and the lower plug 220 to correspond to the guide recess 103 of the interface connector 100, to ensure correct insertion of the interface plug 200 into the interface connector 100.

FIG. 5 illustrates a configuration of the earphone plug 300 connected to the interface connector 100 of FIG. 2. In this configuration, the earphone plug 300 is used for a four-pole earphone 3.

Referring to FIG. 5, connection terminals 302a, 302b, 302c, and 302d are formed in the earphone plug 300 of the general four-pole earphone 3. From the end of the earphone plug 300 corresponding to the connector 101 of the interface connector 100 when the earphone plug 300 is connected to the interface connector 100, the connection terminals 302a to 302d are formed in order of the microphone terminal MIC 302a, ground terminal GND 302b, ear right terminal (EAR-R) 302c, and ear left terminal (EAR-L) 302d. However, the kind and arrangement form the connection terminals 302a to 302d of the earphone plug 300 shown in FIG. 5 are an example only, and are not limited thereto.

When the earphone plug 300 of the four-pole earphone 3 is connected to the interface connector 100, the connection terminals 302a to 302d formed in the earphone plug 300 contact with the plurality of first terminals 112a to 112d and with the plurality of second terminals 122a to 122d, respectively, formed in the upper connector 110 and the lower connector 120 of the interface connector 100.

As described above, the determination unit 130 determines whether one of the earphone plug 300 and the interface plug 200 is connected, and which one thereof, using a first signal output from the second data signal input terminal (D+) 112d formed in the upper connector 110 and a second signal output from the voltage terminal (Vin) 112c. The determination unit 130 detects a corresponding change of a reference voltage supplied from a voltage supply unit (not shown) through the first signal output from the second data signal input terminal (D+) 112d and the second signal output from the voltage terminal (Vin) 112c. When the interface plug 200 is connected to the interface connector 100, the second data signal input terminal (D+) 112d and the voltage terminal (Vin) 112c are connected to the connection terminals 212d and 212c, respectively, of the interface plug 200. Therefore a part of a reference voltage transmitted through the interface plug 200 is reduced by resistance, and thus at least one of the first signal output from the second data signal input terminal (D+) 112d and the second signal output from the voltage terminal (Vin) 112c includes a low value. For example, when the interface plug 200 of a USB cable, or a charging cable, is connected to the interface connector 100, the interface plug 200 receives an electrical signal for performing data communication or for electric charging through the second data signal input terminal (D+) 112d. Thus, the first signal output from the second data signal input terminal (D+) 112d includes a low value.

Alternatively, when the earphone plug 300 is connected to the interface connector 100, the second data signal input terminal (D+) 112d contacts with only the ear left terminal (EAR-L) 302d and thus receives no electrical signal. Thus, the first signal output from the second data signal input terminal (D+) 112d includes a high value.

The described method by which the determination unit 130 determines which of the earphone plug 300 and the interface plug 200 is connected through the first signal and the second signal is an illustration only, and any method of determining values of the first signal output from the second data signal input terminal (D+) 112d and the second signal output from the voltage terminal (Vin) 112c formed in the upper connector 110 can be used.

Therefore, when the earphone plug 300 of the four-pole earphone 3 is connected to the interface connector 100, the second data signal input terminal (D+) 112d and the voltage terminal (Vin) 112c of the upper connector 110 contact with the ear left terminal (EAR-L) 302d and the ear right terminal (EAR-R) 302c, respectively, of the earphone plug 300. Because the second data signal input terminal (D+) 112d and the voltage terminal (Vin) 112c of the upper connector 110 are not connected to each other, both the first signal and the second signal have a high value. Therefore, when both the first signal and the second signal have a high value, the determination unit 130 determines that the earphone plug 300 is connected to the interface connector 100.

In this case, as shown in FIG. 5, the controller 170 controls the switching unit 140 to connect signal lines of the first data signal input terminal (D−) 112a, voltage terminal Vin 112c, and second data signal input terminal D+ 112d formed in the upper connector 110 to signal lines of the microphone terminal (MIC) 122a, ear right terminal (EAR-R) 122c, and ear left terminal (EAR-L) 122d, respectively. Thus, the controller connects the first data signal input terminal (D−) 112a, voltage terminal Vin 112c, and second data signal input terminal D+ 112d to the audio processor 150. Further, the controller 170 controls the audio processor 150 to interrupt sound output through the external speaker SPK and to output sound through the earphone 3. In this case, the controller 170 controls the audio processor 150 to receive a sound signal through the external microphone MIC.

FIG. 5 illustrates the earphone plug 300 used with the four-pole earphone 3, however the interface connector 100 of FIG. 5 can also be applied to an earphone plug used with a three-pole or five-pole earphone.

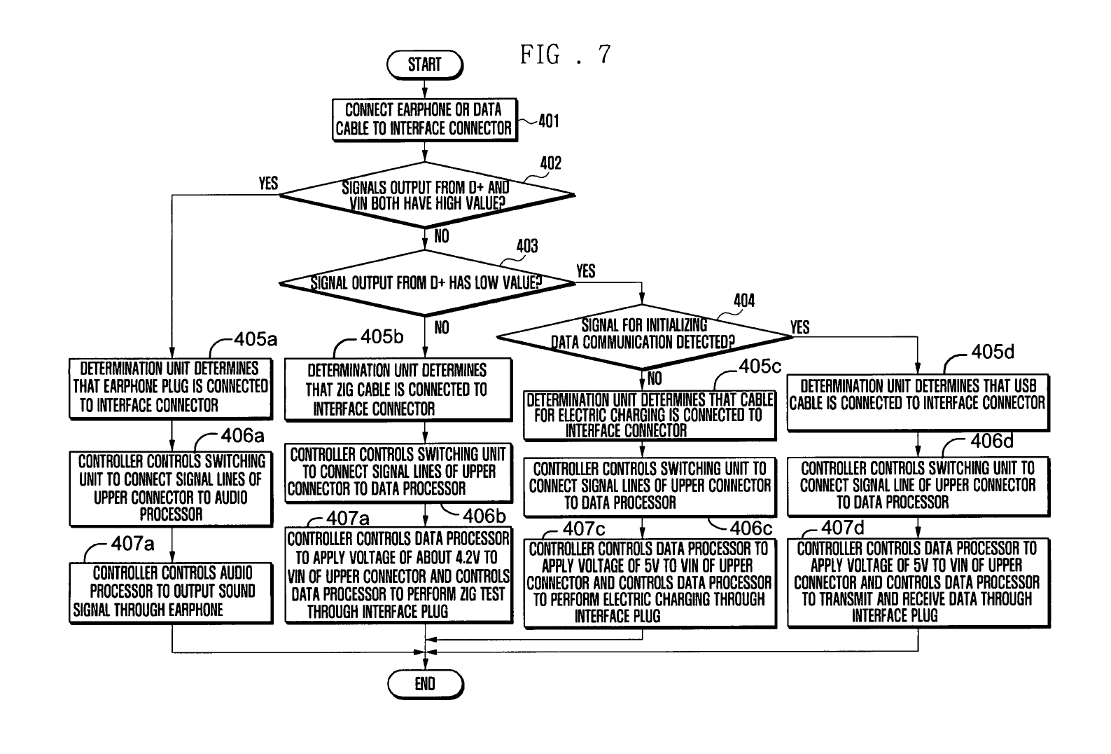

FIG. 6 illustrates a configuration of the interface plug 200 connected to the interface connector 100 of FIG. 2.

Referring to FIG. 6, when the interface plug 200 is connected to the interface connector 100, the plurality of connection terminals 212a to 212d formed in the upper plug 210 contact with the plurality of first terminals 112a to 112d, respectively, formed in the upper connector 110 of the interface connector 100. In this case, a lower surface of the lower plug 220 contacts with the plurality of second terminals 122a to 122d formed in the lower connector 120. However, because the lower surface of the lower plug 220 is not electrically conductive, the lower plug 220 is not electrically connected to the plurality of second terminals 122a to 122d.

When the interface plug 200 is connected to the interface connector 100, the second data signal input terminal (D+) 112d and the voltage terminal (Vin) 112c of the upper connector 110 contact with, and are thereby electrically connected to, the second data signal input terminal (D+) 212d and the voltage terminal (Vin) 212c, respectively, of the upper plug 210. Therefore, when the interface plug 200 is connected to the interface connector 100, at least one of the first signal output from the second data signal input terminal (D+) 112d and the second signal output from the voltage terminal (Vin) 112c includes a low value.

When the second signal has a low value, the determination unit 130 determines that the interface plug 200, not the earphone plug 300, is connected to the interface connector 100.

In this state, if the first signal also includes a low value, the determination unit 130 determines that the interface plug 200 is a plug of a USB cable or a plug of a charging cable. When the first signal includes a low value, if a signal for initializing data communication is detected from the first signal, the determination unit 130 determines that the interface plug 200 is a plug of a USB cable, and if a signal for initializing data communication is not detected from the first signal, the determination unit 130 determines that the interface plug 200 is a plug of a charging cable.

When the determination unit 130 determines that a plug of a USB cable or a plug of a charging cable is connected to the interface plug 200, the controller 170 controls the switching unit 140 to connect signal lines of the first data signal input terminal (D−) 112a, voltage terminal (Vin) 112c, and second data signal input terminal (D+) 112d formed in the upper connector 110 to the data processor 160. Further, the controller 170 controls the data processor 160 to transmit and receive data or to perform electric charging through the interface plug 200. In the case of transmitting and receiving data of performing electric charging, a voltage of 5V is applied to the voltage terminal (Vin) 112c of the upper connector 110.

In a state of the second signal including a lower value, if the first signal includes a high value, the determination unit 130 determines that the interface plug 200 is a plug of a zig cable.

In this case, the controller 170 controls the switching unit 140 to connect signal lines of the first data signal input terminal (D−) 112a, voltage terminal (Vin) 112c, and second data signal input terminal (D+) 112d formed in the upper connector 110 to the data processor 160. Further, the controller 170 controls the data processor 160 to perform a zig test through the interface plug 200. In this case, the controller 170 applies a voltage of about 4.2V to the voltage terminal (Vin) 112c of the upper connector 110.

FIG. 7 illustrates a method of controlling an interface connector according to another exemplary embodiment of the present invention.

The earphone 3 or the data cable 2 is connected to the interface connector 100 (block 401), and the determination unit 130 determines whether the first signal output from the second data signal input terminal (D+) 112d and the second signal output from the voltage terminal (Vin) 112c formed in the upper connector 110 both have a high value (block 402).

If the first signal output from the second data signal input terminal (D+) 112d and the second signal output from the voltage terminal (Vin) 112c formed in the upper connector 110 both include a high value, the determination unit 130 determines that the earphone plug 300 is connected to the interface connector 100 (block 405a). Therefore, the controller 170 controls the switching unit 140 to connect signal lines of the first data signal input terminal (D−) 112a, voltage terminal (Vin) 112c, and second data signal input terminal (D+) 112d formed in the upper connector 110 to signal lines of the microphone terminal (MIC) 122a, ear right terminal (EAR-R) 122c, and ear left terminal (EAR-L) 122d, respectively, of the lower connector 120 to connect the first data signal input terminal (D−) 112a, voltage terminal (Vin) 112c, and second data signal input terminal (D+) 112d to the audio processor 150 (block 406a).

The controller 170 controls the audio processor 150 to interrupt sound output through the external speaker SPK and to output sound through the earphone 3 (block 407a).

If the first signal output from the second data signal input terminal (D+) 112d and the second signal output from the voltage terminal (Vin) 112c formed in the upper connector 110 do not both have a high value at step 402, the determination unit 130 determines whether the first signal output from the second data signal input terminal (D+) 112d formed in the upper connector 110 has a low value (block 403).

If the first signal output from the second data signal input terminal (D+) 112d formed in the upper connector 110 does not have a low value, the determination unit 130 determines that a zig cable is connected through the interface plug 200 to the interface connector 100 (block 405b). Therefore, the controller 170 controls the switching unit 140 to connect signal lines of the first data signal input terminal (D−) 112a, voltage terminal (Vin) 112c, and second data signal input terminal (D+) 112d formed in the upper connector 110 to the data processor 160 (block 406b). Further, the controller 170 controls the data processor 160 to apply a voltage of about 4.2V to the voltage terminal (Vin) 112c of the upper connector 110 and controls the data processor 160 to perform a zig test through the interface plug 200 (block 407b).

If the first signal output from the second data signal input terminal (D+) 112d formed in the upper connector 110 includes a low value at step 403, the determination unit 130 determines whether a signal for initializing data communication is detected from the first signal (block 404).

If a signal for initializing data communication is detected from the first signal, the determination unit 130 determines that a USB cable is connected through the interface plug 200 to the interface connector 100 (block 405d). Therefore, the controller 170 controls the switching unit 140 to connect signal lines of the first data signal input terminal (D−) 112a, voltage terminal (Vin) 112c, and second data signal input terminal (D+) 112d formed in the upper connector 110 to the data processor 160 (block 406d).

The controller 170 controls the data processor 160 to apply a voltage of 5V to the voltage terminal (Vin) 112c of the upper connector 110 and controls the data processor 160 to transmit and receive data through the interface plug 200 (block 407d).

If a signal for initializing data communication is not detected from the first signal at step 404, the determination unit 130 determines that a charging cable is connected through the interface plug 200 to the interface connector 100 (block 405c). Therefore, the controller 170 controls the switching unit 140 to connect signal lines of the first data signal input terminal (D−) 112a, voltage terminal (Vin) 112c, and second data signal input terminal (D+) 112d formed in the upper connector 110 to the data processor 160 (block 406c). Further, the controller 170 controls the data processor 160 to apply a voltage of 5V to the voltage terminal (Vin) 112c of the upper connector 110 and controls the data processor 160 to perform electric charging through the interface plug 200 (block 407c).

As described above, an interface connector and a method of controlling the same of the present invention enable both an earphone plug and an interface plug to be connected to the same interface connector, thereby eliminating a requirement to install a separate earphone connector, and thus enabling space of a mobile terminal to be more effectively used and a cost to be reduced.

Further, because an existing earphone having a conventional earphone plug can be used, it is unnecessary to separately prepare an earphone for a mobile terminal or to use a separate converter plug, thereby improving user convenience.

Further, because a circular connector is formed in the interface connector, as in a conventional earphone connector, an interface plug can be easily inserted and thus damage to the interface connector is prevented.

A mobile terminal for applying an interface connector according to the present invention may be a portable electronic device, such as a mobile phone, personal digital assistant (PDA), navigation device, digital broadcasting receiver, and portable multimedia player (PMP).

Further, a mobile terminal for applying an interface connector according to the present invention may be a slide type, bar type, flip type, folder type, rotating type, and combination type mobile terminal.

Further, an interface connector according to the present invention can be applied to various electronic devices, such as a mobile terminal, MP3 Player, and digital versatile disk (DVD) player.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An interface connector comprising:
an upper connector including a plurality of first terminals;
a lower connector including a plurality of second terminals insulated from the plurality of first terminals;
a determination unit configured to determine which one of an earphone plug and an interface plug is connected to the interface connector through signals output from at least one of the plurality of first terminals and the plurality of second terminals;
a switching unit configured to switch signal lines from the plurality of first terminals to connect the plurality of first terminals to one of:
an audio processor configured to output a sound signal through the earphone plug; and
a data processor configured to perform one of data communication, electric charging, and a zig test through the interface plug, according to the determination result of the determination unit; and
a controller configured to control the determination unit, the audio processor, the data processor, and the switching unit to perform a function corresponding to the connected one of the earphone plug and the interface plug, according to the determination result of the determination unit.

2. The interface connector of claim 1, wherein the upper connector includes a first recess formed longitudinally along an inner surface thereof in which the plurality of first terminals are formed sequentially in a longitudinal direction of the first recess,
the lower connector includes a second recess formed longitudinally along an inner surface thereof in which the plurality of second terminals are formed sequentially in a longitudinal direction of the second recess, and
the lower connector is coupled to the upper connector with the inner surface of the lower connector opposite to the inner surface of the upper connector, and the lower connector electrically insulated from the upper connector, to form a connector into which one of the earphone plug and the interface plug is inserted.

3. The interface connector of claim 2, wherein the interface plug comprises:
an upper plug in which a plurality of connection terminals are formed to contact with the plurality of first terminals when the interface plug is inserted into the connector; and
a lower plug coupled opposite to, and electrically insulated from the upper plug.

4. The interface connector of claim 3, wherein
a guide recess is formed in a longitudinal direction along a side of a coupled surface of the upper connector and the lower connector, and
a projection is formed in a longitudinal direction along a coupled surface of the upper plug and the lower plug to correspond to the guide recess for ensuring correct insertion of the interface plug into the interface connector.

5. The interface connector of claim 3, wherein the plurality of first terminals are formed in order of a first data signal input terminal D−, ground terminal GND, voltage terminal Vin, and second data signal input terminal D+ from the insertion end of the connector, and
the plurality of second terminals are formed in order of a microphone terminal MIC, ground terminal GND, ear right terminal EAR-R, and ear left terminal EAR-L from the insertion end of the connector.

6. The interface connector of claim 5, wherein the plurality of connection terminals of the interface plug are formed in order of the first data signal input terminal D−, ground terminal GND, voltage terminal Vin, and second data signal input terminal D+ from the end of the interface plug corresponding to the insertion end of the connector after the interface plug is inserted.

7. The interface connector of claim 5, wherein the determination unit is configured to determine which one of the earphone plug and the interface plug is connected by detecting a first signal output from the second data signal input terminal D+ and a second signal output from the voltage terminal Vin.

8. The interface connector of claim 7, wherein if the first signal and the second signal both include a high value, the determination unit determines that the earphone plug is connected to the interface connector, and
if the second signal has a low value, the determination unit is configured to determine that the interface plug is connected to the interface connector.

9. The interface connector of claim 7, wherein when the determination unit determines that the interface plug is connected to the interface connector, if the first signal has a low value, the determination unit is configured to determine that the interface plug is one of a plug of a USB cable and a plug of a charging cable, and
if the first signal has a high value, the interface connector is configured to determine that the interface plug is a plug of a zig cable.

10. The interface connector of claim 9, wherein when the first signal has a low value,
if a signal for initializing data communication is detected from the first signal, the determination unit is configured to determine that the interface plug is a plug of a USB cable, and
if a signal for initializing data communication is not detected from the first signal, the determination unit is configured to determine that the interface plug is a plug of a charging cable.

11. The interface connector of claim 8, wherein when the earphone plug is connected to the interface connector,
the controller is configured to connect signal lines of the first data signal input terminal D−, voltage terminal Vin, and second data signal input terminal D+ formed in the upper connector to signal lines of the microphone terminal MIC, ear right terminal EAR-R, and ear left terminal EAR-L, respectively, and control the switching unit to connect the earphone plug to the audio processor, and
when the interface plug is connected to the interface connector,
the controller is configured to control the switching unit to connect signal lines of the first data signal input terminal D−, voltage terminal Vin, and second data signal input terminal D+ formed in the upper connector to the data processor.

12. The interface connector of claim 9, wherein when the interface plug is a plug of a USB cable, the controller is configured to control the data processor to transmit and receive data through the interface plug, and
when the interface plug is a plug of a cable for electric charging, the controller is configured to control the data processor to perform electric charging, and when the interface plug is a plug for a zig cable, the controller is configured to control the data processor to perform a zig test through the interface plug.

13. A method for controlling an interface connector comprising an upper connector including a plurality of first terminals and a lower connector including a plurality of second terminals insulated from the plurality of first terminals, comprising:
determining one of an earphone plug and an interface plug is connected to the interface connector through signals output from at least one of the plurality of first terminals and the plurality of second terminals;
connecting the plurality of first terminals to one of an audio processor for outputting a sound signal through the earphone plug and a data processor for performing one of data communication, electric charging and a zig test through the interface plug, by switching signal lines from the plurality of first terminals according to the determination result; and
controlling a function corresponding to the connected one of the earphone plug and the interface plug, according to the determination result.

14. The method of claim 13, wherein the upper connector includes a first recess formed longitudinally along an inner surface thereof in which the plurality of first terminals are formed sequentially in a longitudinal direction of the first recess,
the lower connector includes a second recess formed longitudinally along an inner surface thereof in which the plurality of second terminals are formed sequentially in a longitudinal direction of the second recess, and
the lower connector is coupled to the upper connector with the inner surface of the lower connector opposite to the inner surface of the upper connector, and the lower connector electrically insulated from the upper connector, form a connector into which one of the earphone plug and the interface plug is inserted.

15. The method of claim 14, wherein the interface plug comprises:
an upper plug in which a plurality of connection terminals are formed to contact with the plurality of first terminals when the interface plug is inserted into the connector; and
a lower plug coupled opposite to, and electrically insulated from the upper connector.

16. The method of claim 15, wherein a guide recess is formed in a longitudinal direction along a side of a coupled surface of the upper connector and the lower connector, and
a projection is formed in a longitudinal direction along a coupled surface of the upper plug and the lower plug to correspond to the guide recess for ensuring correct insertion of the interface plug into the interface connector.

17. The method of claim 15, wherein the plurality of first terminals are formed in order of a first data signal input terminal D−, ground terminal GND, voltage terminal Vin, and second data signal input terminal D+ from the insertion end of the connector, and
the plurality of second terminals are formed in order of a microphone terminal MIC, ground terminal GND, ear right terminal EAR-R, and ear left terminal EAR-L from the insertion end of the connector.

18. The method of claim 17, wherein the plurality of connection terminals of the interface plug are formed in order of the first data signal input terminal D−, ground terminal GND, voltage terminal Vin, and second data signal input terminal D+ from the end of the interface plug corresponding to the insertion end of the connector after the interface plug is inserted.

19. The method of claim 17, wherein determining the one of an earphone plug and an interface plug is connected to the interface connector comprises determining which one of the earphone plug and the interface plug is connected to the interface connector by detecting a first signal output from the second data signal input terminal D+ and a second signal output from the voltage terminal Vin.

20. The method of claim 19, wherein determining the one of the earphone plug and the interface plug is connected to the interface connector comprises:
determining, if the first signal and the second signal both have a high value, that the earphone plug is connected to the interface connector; and
determining, if the second signal has a low value, that the interface plug is connected to the interface connector.

21. The method of claim 19, wherein determining that the interface plug is connected to the interface connector further comprises:
determining, if the first signal has a low value, that the interface plug is one of a plug of a USB cable and a plug of a charging cable; and
determining, if the first signal has a high value, that the interface plug is a plug of a zig cable.

22. The method of claim 21, wherein determining that the interface plug is one of a plug of a USB cable and a plug of a charging cable further comprises:
determining, if a signal for initializing data communication is detected from the first signal, that the interface plug is a plug of a USB cable; and
determining, if a signal for initializing data communication is not detected from the first signal, that the interface plug is a plug of a charging cable.

23. The method of claim 20, wherein connecting the plurality of first terminals to one of the audio processor and the data processor by switching signal lines from the plurality of first terminals comprises:
connecting, if the earphone plug is connected to the interface connector, signal lines of the first data signal input terminal D−, voltage terminal Vin, and second data signal input terminal D+ formed in the upper connector to signal lines of the microphone terminal MIC, ear right terminal EAR-R, and ear left terminal EAR-L, respectively, and connecting the earphone plug to the audio processor; and
connecting, if the interface plug is connected to the interface connector, signal lines of the first data signal input terminal D−, voltage terminal Vin, and second data signal input terminal D+ formed in the upper connector to the data processor.

24. The method of claim 21, wherein controlling the function corresponding to the earphone plug or the interface plug comprises:
controlling, if the interface plug is a plug of a USB cable, the data processor to transmit and receive data through the interface plug;
controlling, if the interface plug is a plug of a cable for electric charging, the data processor to perform electric charging; and
controlling, if the interface plug is a plug of a zig cable, the data processor to perform a zig test through the interface plug.
